(19) United States
(12) Patent Application Publication
(10) Pub. No.: US 2024/0320644 A1
(43) Pub. Date: Sep. 26, 2024

(54) ENABLING RECURRING SERVICE TRANSACTIONS APPLIED TO AN ELECTRONIC PAYMENT METHOD TO BE IDENTIFIED BASED ON HISTORICAL TRANSACTION DATA AND MANAGING SERVICES

(71) Applicant: Capital One Services, LLC, McLean, VA (US)

(72) Inventors: Arjun Srihari, Ashburn, VA (US); Erik Virbitsky, Washington, DC (US); Marisa Lee, Washington, DC (US); Girish Manchapanahalli, Fairfax, VA (US); Sabrina Nijim, Alexandria, VA (US)

(21) Appl. No.: 18/187,205

(22) Filed: Mar. 21, 2023

(51) Int. Cl. G06Q 20/14; G06Q 20/10; G06Q 20/38

(52) U.S. Cl. CPC G06Q 20/145; G06Q 20/102; G06Q 20/389

(57) ABSTRACT

Systems, methods, and apparatuses for determining, based on historical transaction data, that past charges for a merchant service to an electronic payment method of a user correspond to a subscription type recurring transaction, and providing a user with options to manage the service are described. Based on a machine learning model analyzing the historical transaction data comprising past charges for a service of a corresponding merchant of the plurality of merchants, generating a probability that the past charges for the service indicate a subscription type recurring transaction, for the service of the corresponding merchant. Based on the probability exceeding a threshold, determining that the past charges correspond to a subscription type recurring transaction, an expected amount of an upcoming charge and an expected payment date for the upcoming charge. Based on the determining, providing one or more options for a user to alter the subscription type service.

### FIELD OF USE

Aspects of this disclosure relate to computer implemented systems and methods for determining, based on historical transaction data, that past charges for a service of a merchant to an electronic payment method of a user correspond to a subscription type recurring transaction, and providing a user with options to manage the service. More specifically, aspects of the disclosure provide for generating a probability, based on a machine learning model analyzing historical transaction data, that there will be an upcoming charge to the user's electronic payment method for a service of a merchant corresponding to a subscription type recurring transaction, based on the probability exceeding a threshold, allowing a user to manage the subscription.

### BACKGROUND

The popularity of recurring services including subscription services has risen in recent years. Furthermore, traditional types of subscription services that were popular in the past (e.g., newspaper and magazine subscriptions) have been joined and in some cases supplanted by newer types of subscription services. These newer types of subscription services include variations of older types of services as well as entirely new services some of which are electronic in nature (e.g., video streaming services and online gaming services). Further, the ways in which these services may be acquired and cancelled have changed over time. In the past, a user typically would have had to call a merchant/service provider's customer service center, which is open for limited hours such as regular business hours, to cancel or update a subscription. More recently, many subscription services can be updated or cancelled online by a user, with a web browser, going to a merchant's web site and logging in and navigating through several pages to in order to update or cancel their service. The increasing number of these services may contribute to an increase in situations in which a user loses track of the services to which that user is subscribed. For example, 1 in 3 users aged 25-54 have six or more subscription services.

As a result, users may end up inadvertently spending significant amounts of money in the form of unwanted subscription charges that are paid on a recurring basis. Not surprisingly, nearly half of users do not know the exact amount of money they are spending on subscriptions. However, to manage these unwanted services, a user may take the steps of canceling the service or altering their services via calling a customer service center or logging into the merchant's web site. Such methods of cancelling or updating a service can be time consuming, and require the user to know what services they have

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address these and other problems, and generally improve user convenience by allowing a user, via an application executing on a mobile device, to manage a service from a merchant that has been determined, by the financial institution applying a machine learning model to historical transaction data of a user for the service, to be a recurring transaction. In this case, a user can manage recurring transactions (e.g., subscriptions) without the need to call or log on to the merchant's website. Further, while a third party intermediary may be configured to receive the service management instructions from the user, via the financial institution, which are forwarded to the corresponding merchants, the third party intermediary does not have access to the historical transaction data of a user and thus does not have the ability to evaluate past transactions to determine whether the past transactions correspond to a recurring transaction. Applying the historical transaction data of the user to a machine learning model has been found to provide an accurate and reliable way for the financial institution to determine whether a transaction is recurring. Moreover, the financial institution must protect user historical transaction data from with the highest levels of security to maintain user privacy and to otherwise comply with regulatory schemes. Practically, such historical transaction data cannot be made available to the third party intermediary. Additionally, the financial institution also has access to historical transaction data of other users, who employ an electronic payment method associated with the financial institution, for services of the same merchants. The financial institution may utilize that information, which is not available to the third party intermediary, to aid in analyzing whether a transaction is recurring by, for example comparing aspects of other user's transaction details (e.g., merchant, service, charge amount, charge cadence) with aspects of the user transaction data.

More particularly, some aspects described herein may provide a method that comprises storing historical transaction data comprising transaction details for received past charges for services to an electronic payment method of a user, wherein the past charges are associated with a plurality of merchants. The method may comprise generating, based on a machine learning model analyzing the historical transaction data comprising past charges to the electronic payment method for a service of a corresponding merchant of the plurality of merchants, a probability that the past charges for the service indicate a subscription type recurring transaction for the service of the corresponding merchant. Based on the probability exceeding a threshold, the method may comprise determining, by the server, that the past charges correspond to a subscription type recurring transaction for a subscription type service of the corresponding merchant, and determining an expected amount of an upcoming charge and an expected payment date for the upcoming charge. The method may further comprise receiving, from a third party intermediary, notice of one or more options available to a user for altering the subscription type service of the corresponding merchant; and receiving, by an application executing on a mobile computing device, the expected amount of the upcoming charge, the expected payment date for the upcoming charge, an identity of the corresponding merchant, and the one or more options available to the user for altering the subscription type service of the corresponding merchant. Further, the method may further comprise displaying, by the application, the expected amount of the upcoming charge, the expected payment date for the upcoming charge, the identity of the corresponding merchant, and the one or more options available to the user for altering the subscription type service of the corresponding merchant; and receiving, by the application and via user input, an alter instruction to alter the subscription type service of the corresponding merchant. Further, based on receiving the alter instruction, the method may comprise sending, via the third party intermediary to the corresponding merchant, the alter instruction.

In certain aspects, the alter instruction comprises a cancel instruction and the sending, comprises, sending the cancel instruction to cancel the subscription type service of the corresponding merchant. In further aspects based on receiving the cancel instruction to cancel the subscription type service, the method may comprise displaying, by the application, an offer to continue the subscription type service. In still further aspects the method may comprise receiving, by the application and via second user input, an instruction rejecting the offer to continue the subscription type service, and wherein sending the cancel instruction is further based on receiving the instruction rejecting the offer to continue the subscription type service. In still another aspect, the method may comprise displaying, by the application based on receiving the alter instruction and after the subscription type service has been canceled, an option to reactivate the subscription type service. And still further, the method may comprise receiving, by the application and via second user input, a reactivation instruction to reactivate the subscription type service, and sending, via the third party intermediary to the corresponding merchant, the reactivation instruction to reactivate the subscription type service.

In other aspects, the method may comprise, prior to sending the alter instruction, prompting the user, by the application, to confirm the alter instruction to alter the subscription type service, and receiving, via second user input, confirmation of the alter instruction to alter the subscription type service.

In another aspect, the subscription type service of the corresponding merchant may comprise a first service plan, and the alter instruction may comprise an instruction to change the first service plan to a second service plan different from the first service plan.

In still other aspect, the alter instruction may comprise a pause instruction, and the sending, may comprise, sending the pause instruction to pause the subscription type service. In a further aspect, the one or more options to alter the subscription type service may comprise an option to pause the subscription type service for a first period and an option to pause the subscription type service for a second period different from the first period.

According to some aspects, the method may comprise training the machine learning model based on steps comprising inputting the historical transaction data for the service of the corresponding merchant into the machine learning model; based on the machine learning model and the historical transaction data, generating output comprising predicted probabilities that the past charges represent subscription type recurring transactions for the service of the corresponding merchant; and adjusting a weighting of parameters of the machine learning model based on an accuracy of the predicted probabilities.

According to certain other aspects, the display of the method may comprise displaying the expected amount of the upcoming charge, the expected payment date for the upcoming charge, and the identity of the corresponding merchant in a subscription type recurring transaction list with information of a subscription type recurring transaction for a subscription type service of another merchant, the information of the other merchant comprising an expected amount of the upcoming charge and an expected payment date for the upcoming charge for the subscription type service of the other merchant, and the identity of the other merchant.

According to some aspects described herein, the one or more of the past charges comprise a card verification value (CVV) field, and the machine learning model may be further configured to perform steps comprising determining, based on the CVV field, that the probability of the one or more past charges being based on a subscription type recurring transaction is negatively correlated with the CVV field indicating that one or more of the past charge were based on a card present transaction.

According to some aspects described herein, the transaction details for one or more of the past charges may comprise a payment method field, and the machine learning model may be further configured to perform steps comprising determining, based on the payment method field, that the probability of the past charges being based on a subscription type recurring transaction is negatively correlated with the payment method field indicating that the past charges are based on a card transaction using a card reader device or a mobile wallet transaction using a mobile device and a contactless point of sale system.

According to some aspects described herein, the transaction details for one or more of the past charges may comprise a merchant category code field, and the machine learning model may be further configured to perform steps comprising determining, based on the merchant category code field, that the probability of the past charges being based on a subscription type recurring transaction is positively correlated with the merchant category code field indicating that a category of goods or services provided by the merchant correspond to a subscription type recurring transaction.

According to some aspects described herein, the transaction details for one or more of the past charges may comprise a recurring transaction field, and the machine learning model may be further configured to perform steps comprising determining, based on the recurring transaction field, that the probability of the past charges being based on a subscription type recurring transaction is positively correlated with the recurring transaction field indicating that the past charges corresponded to a subscription type recurring transaction.

According to some aspects described herein, the transaction details for one or more of the past charges may comprise a transaction description field, and the machine learning model may be further configured to perform steps comprising determining, based on the transaction description field, that the probability of the past charges being based on a subscription type recurring transaction is positively correlated with one or more key words describing the past charges as a subscription type recurring transaction.

According to some aspects described herein, a non-transitory computer readable medium having instructions stored thereon that, when executed by one or more processors, may cause the one or more processors to perform steps comprising storing, historical transaction data comprising transaction details for received past charges for services to an electronic payment method of a user, wherein the past charges are associated with a plurality of merchants, and based on a machine learning model analyzing the historical transaction data comprising past charges to the electronic payment method for a service of a corresponding merchant of the plurality of merchants, generating a probability that the past charges for the service indicate a subscription type recurring transaction for the service of the corresponding merchant. The steps may further comprise, based on the probability exceeding a threshold, determining that the past charges correspond to a subscription type recurring transaction for a subscription type service of the corresponding merchant, and determining an expected amount of an upcoming charge and an expected payment date for the upcoming charge. Further, the steps may comprise receiving, from a third party intermediary, notice of an option available to a user for cancelling the subscription type service of the corresponding merchant; and providing, to an application executing on a mobile computing device and for display, the expected amount of the upcoming charge, the expected payment date for the upcoming charge, an identity of the corresponding merchant, and the option available to the user for cancelling the subscription type service of the corresponding merchant. Still further, the steps may comprise receiving, from the application, a cancel instruction to cancel the subscription type service of the corresponding merchant, and based on receiving the cancel instruction, providing, to the application for display, an offer to continue the subscription type service. Additionally, the steps may comprise receiving from the application one of a first indication that the offer to continue the subscription type service was accepted by the user or a second indication that the offer to continue the subscription type service was declined by the user. The method may further comprise based on receiving the first indication, sending, via the third party intermediary to the corresponding merchant, service update information updating terms of the subscription type service for the user, and based on receiving the second indication, sending, via the third party intermediary to the corresponding merchant, the cancel instruction.

According to some aspects described herein, a method may comprise storing historical transaction data comprising transaction details for received past charges for services to an electronic payment method of a user, wherein the past charges are associated with a plurality of merchants. The method may comprise generating, based on a machine learning model analyzing the historical transaction data comprising past charges to the electronic payment method for a service of a corresponding merchant of the plurality of merchants, a probability that the past charges for the service indicate a subscription type recurring transaction for the service of the corresponding merchant. Based on the probability exceeding a threshold, the method may comprise determining, by the server, that the past charges correspond to a subscription type recurring transaction for a subscription type service of the corresponding merchant, and determining an expected amount of an upcoming charge and an expected payment date for the upcoming charge. The method may further comprise receiving, from a third party intermediary, notice of an option available to a user for updating the electronic payment method for the subscription type service of the corresponding merchant, and receiving, by an application, an amount of the upcoming charge, an identity of the corresponding merchant, and the option available to the user for updating the electronic payment method for the service of the corresponding merchant. Further, the method may comprise displaying, by the application, the expected amount of the upcoming charge, the expected payment date for the upcoming charge, the identity of the corresponding merchant, and the option available to the user for updating the electronic payment method for the subscription type service of the corresponding merchant. Additionally, the method may comprise receiving, by the application and via user input, an update instruction to update the electronic payment method for the subscription type service of the corresponding merchant, and based on receiving the update instruction, sending, via the third party intermediary to the corresponding merchant, the update instruction for updating the electronic payment method.

Corresponding apparatuses, devices, systems, and computer-readable media (e.g., non-transitory computer readable media) are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects of the disclosure;

FIG. 2 illustrates an example system which may be used to one or more aspects of the disclosure in accordance with one or more illustrative aspects of the disclosure;

FIGS. 3A and 3B provides an illustrative flowchart representation of the process of determining whether historical transaction data corresponds to a recurring transaction and providing one or more subscription management options for managing the service corresponding to the recurring transaction according to one or more aspects of the disclosure;

FIG. 4 is an illustrative flowchart of a machine learning model determining a probability that the historical transaction data corresponds to a recurring transaction according to one or more aspects of the disclosure;

FIG. 5 is an illustrative flowchart of one aspect of FIG. 3, in which the machine learning model is trained using various training data according to one or more aspects of the disclosure;

FIG. 6A illustrates an example user interface display screen of a user's financial institution mobile app showing expected upcoming bills for recurring subscription type recurring transactions according to one or more aspects of the disclosure;

FIG. 6B illustrates an example user interface display screen of a user's financial institution mobile app showing selection of an example service management option (cancel service) and a further illustrative user interface display screen of an authorization form based on the selection of the cancel service option according to one or more aspects of the disclosure;

FIG. 6C illustrates an example user interface display screen of a user's financial institution mobile app showing an illustrative cancel pending confirmation generated based on a user submitting the illustrative authorization form in FIG. 6B according to one or more aspects of the disclosure.

FIG. 7 illustrates an example user interface display screen of a user's financial institution mobile app showing an illustrative block charges confirmation based on block charges management option having been selected according to one or more aspects of the disclosure;

FIG. 8A shows an example of an overlay that may appear on a user interface display screen of a user's financial institution mobile app based on a user selecting a pause service management option according to one or more aspects of the disclosure;

FIG. 8B shows an example of an overlay that may appear on a user interface display screen of a user's financial institution mobile app based on a user selecting an update service management option according to one or more aspects of the disclosure;

FIG. 8C illustrates an example user interface display screen of a user's financial institution mobile app showing an illustrative offer to not cancel service confirmation according to one or more aspects of the disclosure;

FIG. 9 illustrates an example user interface display screen of a user's financial institution mobile app showing an illustrative screen including upcoming transactions and inactive subscription services according to one or more aspects of the disclosure;

FIG. 10 is an illustrative flowchart representation of a machine learning model determining a probability that a user's historical transaction data including past charges indicate a subscription type recurring transaction according to one or more aspects of the disclosure; and

FIG. 11 is an illustrative flowchart representation of the process for training a transaction identification model according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

There has been an increase in the popularity of subscription services to which a user (e.g., a consumer) may subscribe and receive some goods and/or services on a fixed (e.g., a one year subscription that ends after one year) or open-ended basis (e.g., a month to month subscription that continues indefinitely or until canceled). These good or services may include subscriptions to online streaming media services, fitness club memberships, food delivery services, online gaming services, or any other goods or services to which a user may create a subscription and pay incoming charges for the service on a recurring basis. For example, a user may subscribe to a gaming service that charges an agreed upon amount on a monthly basis. While recurring payments for services is convenient and relieves the user of the burden of having to repeatedly perform the steps of manually paying for a service it may also create issues for the user. For example, it may be difficult for a user to keep track of the services to which the user is currently subscribed, and which services are recurring. Further, a user may lose track of services that are used infrequently or sporadically.

To manage a service subscription, such as to cancel or update a service, the user may call the merchant (or the merchant's customer service line) providing the service, log in to their account on the merchant's website or via a mobile application and navigate through several pages/screens. Financial institutions, which provide an electronic payment method (e.g., debit card or credit card), to which an incoming charge or upcoming charge for a recurring service is applied, in the past have provided no mechanism to allow a user to communicate with merchant to cancel or update their service. Financial institutions may comprise a bank, credit union, savings and loans, wealth management company or other entity that issues transaction cards usable for processing transactions for goods and services.

The financial institution can allow a user to block charges from a merchant, without notifying the merchant prior to the merchant attempting to obtain payment for an incoming charge as described in co-pending. U.S. patent application Ser. No. 18/086,836 filed Dec. 22, 2022 and co-pending U.S. patent application Ser. No. 18/051,705 filed Nov. 1, 2022, both of which are incorporated by reference herein.

In some instances, the financial institution can determine if the user has signed up for a trial for a service and provided an electronic payment method to be charged when a payment comes due for the service such as the end of the trial. When determining that a user has signed up for a trial, the financial institution may notify the user, prior to a payment coming due (e.g., end of the trial), that the electronic payment method is scheduled to be charged for the service and, provide the user with an option to block charges from the merchant. If the user requests to block charges from the merchant, the financial institution may place the merchant on a blocked merchant list. When transaction data including the incoming charge for the service is received from the merchant, the financial institution may determine, by a machine learning model and based on incoming charge data, that the incoming charge is most likely (e.g., a probability exceeding a threshold probability) from a merchant included in the blocked merchants list and based on determining that the charge is most likely from the merchant, the financial institution can provide the user with the ability to block the incoming charge from being applied to the electronic payment method.

In another example, when the incoming charge data is received from the merchant, the financial institution may determine, based on a machine learning model and the incoming charge data, a probability of the incoming charge being for a preauthorized recurring transaction from the merchant (rather than an unauthorized recurring transaction). If the probability exceeds a threshold probability, then the incoming charge will not be processed and blocked. Otherwise, if the probability does not exceed the threshold probability, then the incoming charge is not for a preauthorized recurring transaction and will be processed and not blocked.

According to the above examples in which the incoming charge is blocked and not processed, the merchant first learns that charges have not been processed when there is an attempt made to apply a charge for the service to the user's electronic payment method and the charge is declined. The financial institution sends notification of the declined charge to the merchant who typically will attempt to process the charge several more times. Ultimately, the merchant will need to contact the user, for example, via email or telephone to ultimately determine whether the user wishes to continue with the service or cancel the service. This is cumbersome for both the merchant and the user. For example, the user may not wish to speak with the merchant about their desire to cancel the service, and simply want to just cancel the service. It would be beneficial for the user if they could cancel the service, or take other actions, regarding the service, without the need to directly interact with the merchant such as via phone, merchant mobile app or merchant website.

In some instances, it may be advantageous to utilize a third party intermediary that provides APIs that allows a bank to provide its customers with subscription management options to manage their subscriptions from the bank mobile app. The third party intermediary may have established relationships with subscription business merchants where each merchant can choose one or more subscription management options to be made available for customers through the customer's financial institution. The third party intermediary can send the subscription management options available to a financial institution. The financial institution in turn can make the subscription management options available to their customers through their mobile app. A customer of the financial institution may select a subscription management option, and subscription management instruction may be sent, via the third party intermediary, to the merchant. Subscription management options that may be provided include options to allow a user to cancel subscriptions and recurring payments, upgrade or downgrade subscription plans, pause and resume subscriptions, update payment methods for subscriptions, and receive real-time offers at time of cancellation, and resubscribe.

While a third party intermediary may be configured to receive service management instructions from the user, via the financial institution, and then forward those instructions to the corresponding merchants, the third party intermediary does not have access to the historical transaction data of a user and thus does not have the ability to evaluate past transactions and thus cannot determine which of a user's past transactions for services correspond to subscription type recurring transactions. In some instances, the user may have conducted other recurring or non-recurring transactions provided by the same merchant (e.g., Google, Amazon, Microsoft). Thus, there is a need for the financial institution to determine if a particular service of the corresponding merchant is a particular recurring transaction to prevent the possibility of the wrong recurring transaction or a non-recurring transactions being managed (e.g., paused or canceled). The financial institution maintains historical transaction data including historical transaction data regarding a user's past transaction history and can train a machine learning model based on the user's transaction history. Probabilities may be generated, based on the machine learning model and historical transaction data, that past charges correspond to recurring transactions. By analyzing historical transaction data, a financial institution may apply a machine learning model to generate an accurate prediction to an upcoming charge. Also, a predicted amount of the upcoming charge prediction a predicted date when an upcoming charge will be applied to a user's electronic payment method can be generated by a computing device of the financial institution. Thus, the user can, via the financial institution mobile app, be presented with a list of upcoming charges for specific subscription services determined to be recurring transactions on the display of their mobile device separately from other transactions, and manage the subscription services by selecting a subscription management option such as pause, cancel, or update payment method.

Moreover, the financial institution must protect user historical transaction data with the highest levels of security to maintain user privacy and to otherwise comply with regulatory schemes. Practically, such historical transaction data cannot be made available to the third party intermediary. Additionally, the financial institution also has access to historical transaction data of other users, who employ an electronic payment method associated with the financial institution, for services of the same merchants. The financial institution may utilize that information, which is not available to the third party intermediary, to aid in analyzing whether a transaction corresponds to a recurring transaction or subscription type recurring transaction by, for example comparing aspects of other user's transaction details (e.g., merchant, service, charge amount, charge cadence) with aspects of the historical user transaction data. Further, the financial institution may evaluate various data fields such as a description field of the past transactions to determine if the past charges may be associated with ground truth labels indicating whether each of the past transactions is a subscription type recurring transaction rather than an instance in which a user has, for example, made a purchase on the same day for several consecutive weeks. These aspects of historical transaction data may further contribute to improving the accuracy of determining whether a transaction is recurring and whether a transaction is a subscription type recurring transaction.

It is virtually impossible for the third party intermediary to provide options for modifying all subscription related recurring transactions. However, the financial institution can identify all subscription related recurring transactions and provide at least the option to block charges (as disclosed in co-pending, U.S. patent application Ser. No. 18/086,836 filed Dec. 22, 2022 and co-pending U.S. patent application Ser. No. 18/051,705 filed Nov. 1, 2022) for services of merchants that the third party intermediary does not provide any options for managing the recurring transaction. That is, according to aspects of the disclosure, services associated with subscription type recurring transactions, whether or not supported by the third party intermediary, can managed.

All recurring transactions are not subscription type recurring transactions. For example, a user may make recurring purchases (e.g., payment for three meals purchased from the same restaurant on three consecutive Saturday evenings) that are not subscription type purchases. Subscription type services are charged to a previously designated (previously authorized by the user) electronic payment method of a user without the user having to manually make a payment time of a transaction at the regular cadence. The user may designate an electronic payment method at the time of signing up for the subscription type service, which may be required by certain subscription type service merchants, or during the period of service, at the user's discretion, should the user wish to have the service charge applied at a regular cadence rather than having to manually pay a bill at the regular cadence. The disclosed technology addresses and resolves these issues by leveraging the use of a machine learning model that is configured to determine the probability that past charges associated with a merchant are for a subscription type recurring transaction. The determined probability that the past charges correspond to a subscription type recurring transaction may then be used to determine whether an upcoming charge should be presented to the user to provide a user with one or more options to alter the service associated with the upcoming charge such as by canceling, pausing, or updating the service, or an option allowing the user to update the payment method for the service associated with the subscription type recurring transaction. Based on determining that past charges correspond to a subscription type recurring transactions of a merchant, a predicted upcoming charge amount and payment date for the upcoming charge can be presented to a user for managing their predicted upcoming transactions.

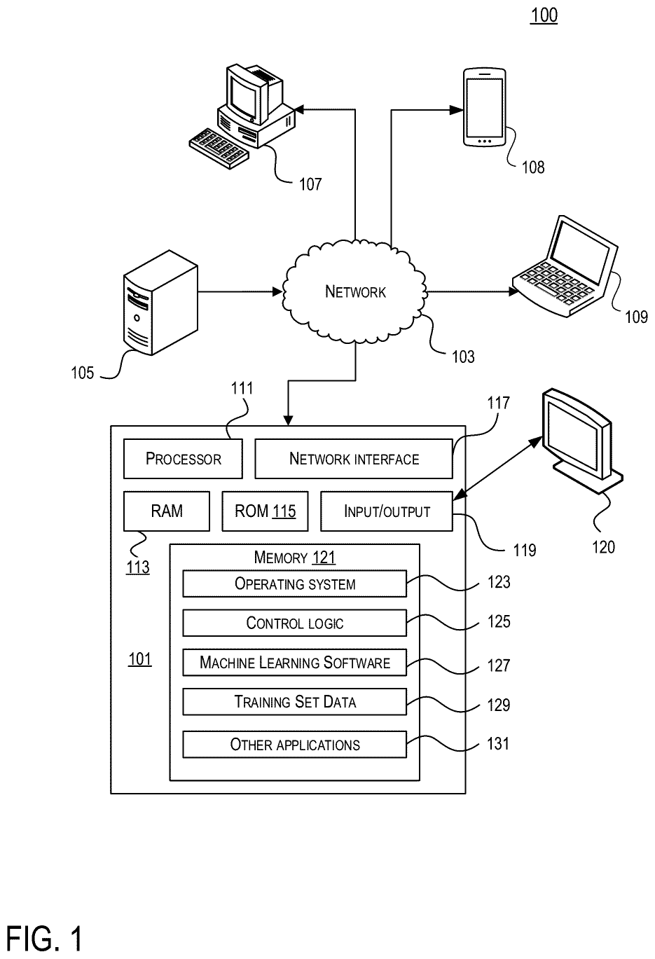

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in some embodiments, operate in a standalone environment. In other embodiments, computing device 101 may operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127 (e.g., software comprising instructions to implement a machine learning model), training dataset 129, and other applications 131. Control logic 125 may be incorporated in and may be a part of machine learning model 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or device 105, 107, 108, 109) as described herein may be spread across multiple data processing devices, for example, to distribute processing load across multiple computers, to segregate transactions based on geographic location, user access level, quality of service (QOS), etc. For example, devices 101, 105, 107, 108, 109, and others may operate in concert to provide parallel computing features in support of the operation of control logic 125 and/or machine learning model 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

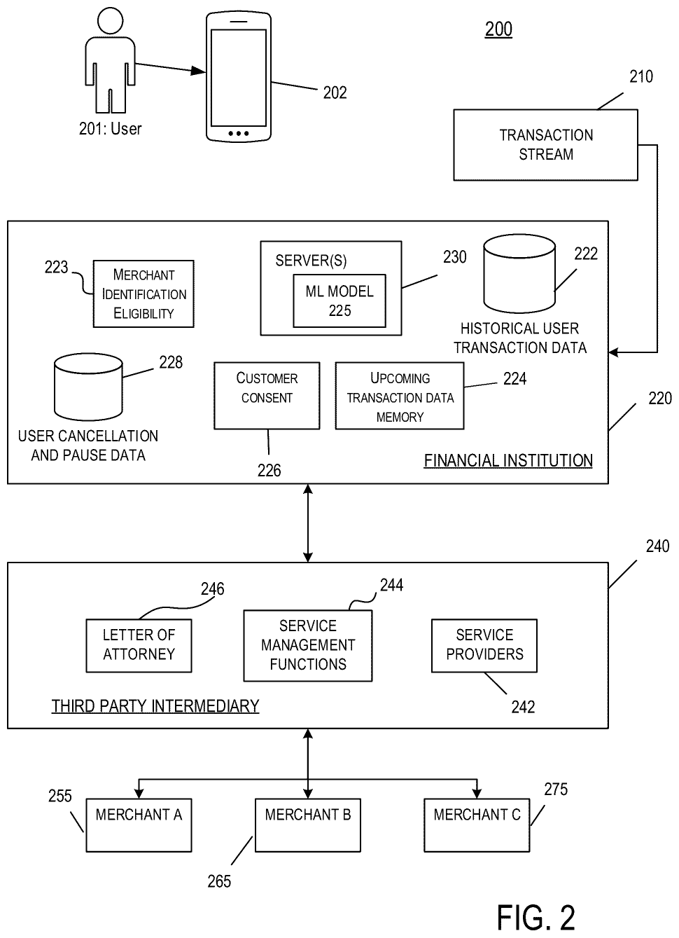

FIG. 2 depicts a diagram of an illustrative system 200, which may be employed according to certain aspects of the disclosure. The system 200 may include a mobile computing device such as mobile phone 202 of a customer or user 201, which is configured to execute a mobile app of financial institution 220, and customer (user) transaction stream 210 for incoming charges to an electronic payment method of the user. Further, the system 200 may include financial institution 220, third party intermediary 240, and a plurality of merchants such as merchant A 255, merchant B 265 and merchant C 275.

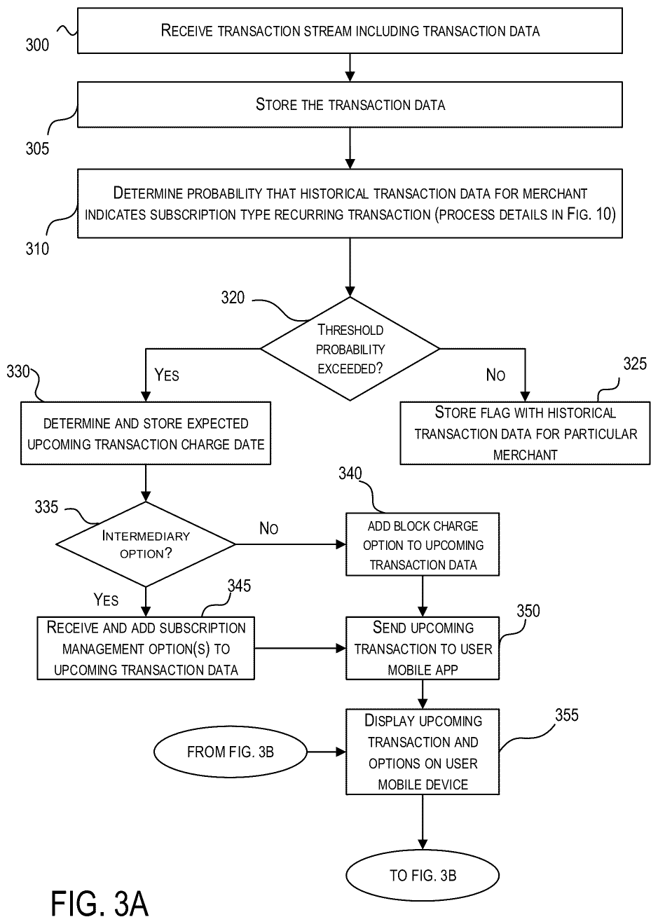

FIGS. 3A and 3B depict an illustrative method flow for determining whether historical transaction data of an individual user including past charges associated with a service of one merchant indicates a subscription type recurring transaction, which is expected to have an upcoming payment date, and providing the user with one or more options to manage the service. FIGS. 3A and 3B provide a high-level representation of one example for this process and will be described with reference to FIGS. 1 and 2.

According to an illustrative operation of the system of FIG. 2, server(s) 230 such as computing device(s) (e.g., computing device 101) of financial institution 220 may receive a transaction stream 210 from a payment processor in step 300, which provides customer transaction data for incoming charges from merchants to an electronic payment method of a user (customer). It will be appreciated that the terms server and computing device may be used interchangeable herein. The transaction stream 210 may include transaction data for multiple users of electronic payment methods of the financial institution. Alternatively, the server(s) may receive multiple transactions streams, where each stream includes transaction data for one user of an electronic payment method provided by the financial institution. The transaction stream(s) 210 may be received daily.

The transaction data for each individual transaction may be included in the transaction stream 210 at or close to the time of the transaction associated with the incoming charge, or at a time that is not closely proximate to the time of the transaction associated with the incoming charge (e.g., the day after the transaction). Further, the transaction data may be structured in accordance with a data standard used to process payments electronically and/or to exchange electronic transactions using payment cards (e.g., the transaction data may be structured in accordance with the ISO 8583 standard or another standard that is used for financial transaction card messages). The incoming charge may for example comprise an incoming charge for some good and/or services such as an incoming charge for a subscription to an online video streaming service or the purchase of an article of clothing.

The transaction data may comprise a merchant identifier field that indicates the name of the merchant and/or a merchant identifier (e.g., a numeric code) that may be used to identify the merchant associated with the incoming charge, a merchant category code (MCC), the amount of the charge, the date of the charge, and a transaction description of the charge. Further, the transaction data may comprise an electronic payment method field that may indicate a payment method that was used as part of the transaction. For example, the payment method may comprise a transaction card such as a credit card number, a debit card number, or a virtual card numbers (VCNs), or mobile wallet associated with the financial institution. In some cases, the transaction data may include a recurring transaction field indicating that that the incoming charge is a recurring transaction. Also, the transaction data including the electronic payment method field may comprise a transaction card verification value (CVV) field. According to some aspects, the transaction data may be structured in accordance with the ISO 8583 API. In other aspects, the transaction data may be structured in accordance with any API accepted and processed by one or more computing devices of financial institution 220 by a payment processor.

The incoming charge may indicate a good or service for which a user may receive an incoming charge. The merchant identifier may comprise data that may be used to identify the merchant, and may comprise the merchant's name, a merchant ID number, and/or descriptive text that may comprise merchant-identifying information The CVV may indicate a card verification value that is used to improve security for credit card transactions, the presence of which may indicate that the incoming charge is associated with a credit card transaction. The merchant MCC may indicate the type of goods and/or services the merchant provides. The transaction description may comprise a free form text description of the goods and/or services associated with the incoming transaction. The amount of the incoming charge may indicate a monetary value (e.g., a dollar amount or euro amount) associated with the incoming charge.

Following receipt of each transaction stream, financial institution 220 may process the incoming charges for each corresponding user and then the server 230 may store the transaction data as historical transaction data in user transaction data storage 222 associated with the financial institution in step 305. User transaction data storage 222 may include cloud storage or local storage accessible by the server(s) 230, and may be distributed on a distributed network of the financial institution, similar to network 103, and on computing devices similar to computing devices 101 and/or 105.

The user transaction data storage 222 may store user transaction data for each user of financial institution 220 and may maintain that data in storage indefinitely or for a preset period of time (e.g., three years). Thus, the user transaction data storage 222 maintains historical transaction data for each user including past transaction details such as identity of the merchant for each past charge, date of past charges, amount of past charges, and transaction description of past charges.

The identity of the merchant may be represented by different identifiers for different transactions. To avoid not being able to assemble an accurate set of historical data, financial institution may maintain a mapping of merchant identifiers to merchant names.

Financial institution 220, for a user, may determine periodically, such as daily or responsive to a charge being received and processed to the user's electronic payment method for a service of a particular merchant, the probability that the historical transaction data, which includes past charges associated with the particular merchant, indicates that the past charges represent a subscription type recurring transaction that is expected to have an upcoming payment date in step 310. Examples of subscription type services for such subscription type recurring transactions may include streaming media subscription services like HBO Max™, food delivery services like HelloFresh™, gym memberships such as Anytime Fitness™, fruit of the month club, mobile phone service, cable service, or any other services or benefits obtained by making a payment according to a regular cadence.

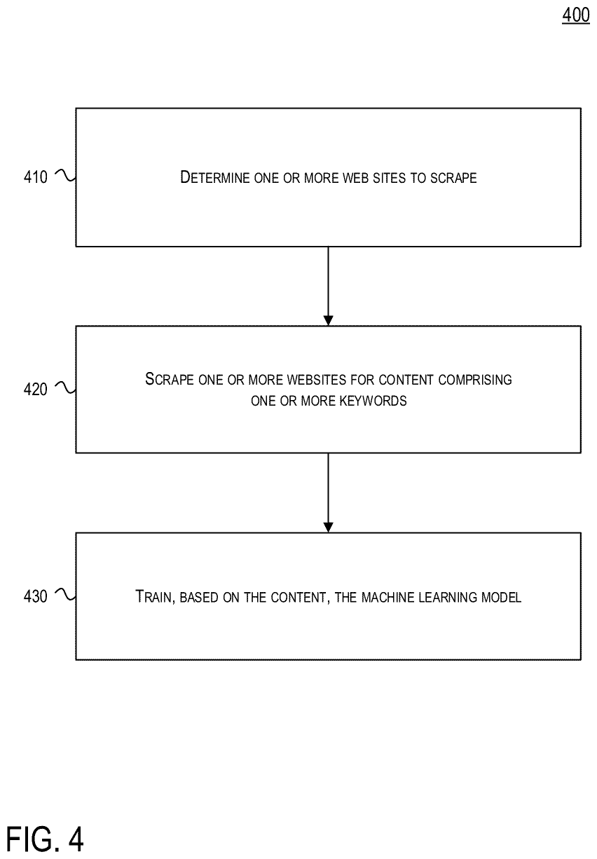

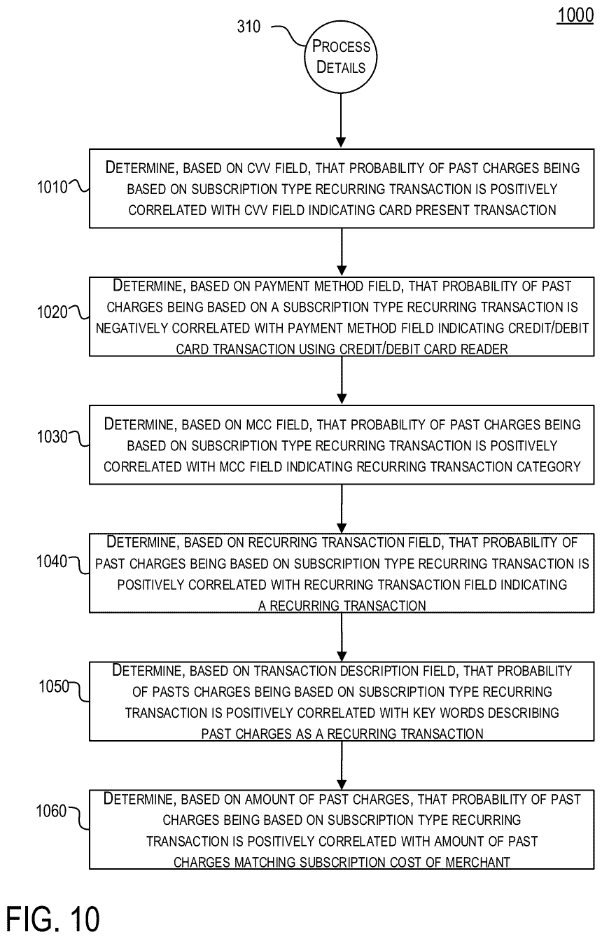

In step 310, the server(s) 230 may determine, based on a machine learning model 225 and the historical transaction data, a probability that historical transaction data of the user for past charges from a particular merchant indicates a subscription type recurring transaction for a service of the particular merchant. FIG. 10, described later herein, provides an example of process details of step 310. Machine learning model 225 may be configured to identify subscription type recurring transactions based on the historical transaction data. For example, machine learning model 225 may receive the user's historical transaction data comprising transaction details for received past charges applied to their electronic payment method. The machine learning model may then perform operations on the received historical transaction data. The operations may comprise determining features of the historical transaction data that may be used to determine a probability that the past transactions associated with the particular merchant included in the historical transaction data indicate a subscription type recurring transaction. The machine learning model may then generate an output comprising a probability that the past charges from the particular merchant for a service indicate a subscription type recurring transaction and a prediction of an expected date of the next (upcoming) transaction. An example of training of the machine learning model is described with respect to FIG. 5.

In step 320, based on the probability (e.g., the probability that the past charges for the particular merchant indicate a subscription type recurring transaction) not exceeding a threshold probability, the past charges for the service of the particular merchant may be identified as past transactions, which do not correspond to a subscription type recurring transaction (e.g., charges from a merchant, which may vary in amount and/or charges which do not occur at a regular cadence). In this case, depending on the relative probability, in step 325 (step 320: yes), a flag, a value, or words may be stored in a recurring transaction field or transaction description field with the historical transaction data for the service of the particular merchant in historical user transaction data store 222. For example, words may be stored in the transaction filed indicating that the historical transaction data is associated with a series of one of food purchases. A flag, for example, may represent that the past charges do not indicate the historical transaction data for the service of the particular merchant is a subscription type recurring transaction. The flag may be applied by machine learning model 225 in the future as a weighting factor (e.g., a negative factor based on the previously determined probability) in the event that machine learning model 225 analyzes again the historical transaction data for the service of the particular merchant such as after more recent historical transaction data for the service of the particular merchant has been stored in historical user transaction data store 222. For example, the probability determined by machine learning model 225 may be compared to the threshold probability and if the probability is less than or equal to the threshold probability then step 330 may be performed.

Based on the probability exceeding a threshold probability (step 320: yes), the server 230 and/or machine learning model 225 based on the regular cadence (e.g., monthly, annually, quarterly) between success past charge dates and/or information from the historical charge data of other users for the service from the same merchant can determine (e.g., predict) the expected upcoming charge date that an expected upcoming charge for the service of the merchant will be processed and store the upcoming transaction data including the expected upcoming charge data in upcoming transaction data memory 224 in step 330. In the case that the probability exceeds the threshold indicating that the historical transaction data for the service of the particular merchant corresponds to a subscription type recurring transaction, a flag, a value or words may be stored in a recurring transaction field or transaction description field with the historical transaction data for the service of the particular merchant in historical user transaction data store 222. The information stored store may indicate that the transaction is a subscription type recurring transaction (e.g., the description in the transaction field may indicate that the historical transaction data is associated with a subscription to a gaming service).

The server 230 may receive user feedback with respect to an accuracy with which the machine learning model identifies subscription type recurring transactions. Further, as part of the process of receiving user feedback a request for user feedback may be sent, via the mobile app to a user and the request for user feedback may comprise questions regarding the accuracy with which the machine learning model identified expected upcoming transactions including the merchant, expected amount and expected payment date. The user may then provide feedback responding in the mobile app, which may forward the feedback to server 230. Server 230 may adjust the threshold probability based on the user feedback. For example, if the user feedback indicates that an expected upcoming transaction was inaccurately determined to be a subscription type recurring transaction, the computing device may increase the threshold probability. As such, the machine learning model will have to determine a greater probability that historical transaction data corresponds to a subscription type recurring transaction before identifying an expected upcoming transaction based on the historical transaction data.

In step 335, server 230 may send, to a service provider API 242 of third party intermediary 240, a query asking what subscription management options are available for the service of the merchant corresponding to the upcoming transaction charge. The query may include a merchant identifier and a service identifier. Third party intermediary 240 may determine whether there are any subscription management options available for the service of the merchant corresponding to the upcoming charge. If the merchant identifier corresponds to an identifier of a merchant which third party intermediary 340 supports, for example Merchant A 255, Merchant B 265, or Merchant C 275, then it may be determined whether the third party intermediary supports one or more subscription management options corresponding to the service represented by the service identifier. If third party intermediary 240 supports one or more subscription management options, the third party intermediary may send a notice of the available subscription management options to server 230. Subscription management options that may be provided include options to allow a user to cancel subscriptions and recurring payments, change (e.g., upgrade or downgrade) subscription plans, pause and resume subscriptions, update payment methods for subscriptions, and receive real-time offers at time of cancellations, and offers to resubscribe after cancellation.

If third party intermediary 240 does not support subscription management options for the service of the merchant corresponding to the upcoming transaction charge (step 335: no), then the third party intermediary may send a message to server 230 that subscription management is not supported and the server carries out step 340. In step 340, server 230 may associate a block charges or allow charges option with the upcoming transaction, by adding the block charge option to the upcoming transaction data in upcoming transaction data memory 224. The block charges function may be configured by the financial institution (inhouse management option) to allow a user to block charges for the upcoming transaction when the user cannot, for example, cancel service by communicating with the merchant via third party intermediary 240. The financial institution can allow a user to block charges from a merchant, without notifying the merchant prior to the merchant attempting to obtain payment for an incoming charge as described in co-pending. U.S. patent application Ser. No. 18/086,836 filed Dec. 22, 2022 and co-pending U.S. patent application Ser. No. 18/051,705 filed Nov. 1, 2022, both of which are incorporated by reference herein. An example of the implementation specifics of block charge function is described in these co-pending applications.

Financial institution 200 may maintain an merchant identification eligibility store 223, which may map the merchants and/or merchant/service combinations to whether or not the merchant and/or merchant/service combinations are supported (provide service management options) by third party intermediary 240. Rather than constantly querying third party intermediary 240, server 230 may determine the support status of a merchant or merchant/service combination by referencing the merchant identification eligibility store 223. Periodically, such as weekly or monthly, the server 230 may send to third party intermediary 240 a bulk query regarding the current support status of all the merchants and/or merchant/service combinations which were not previously supported. Based on third party intermediary 240 providing a status update, the server 230 may update the mapping of the merchants and/or merchant/service combinations maintained in the merchant identification eligibility store 223.

After adding the block charge option to the upcoming transaction data in step 340, server 230 may send upcoming transaction data to financial institution mobile app on user mobile device 202 in step 350. Mobile device 202 may be similar to device 108 in FIG. 1 and may have similar or different architecture as described with respect to computing device 101. The upcoming transaction data may include expected upcoming charge date, expected upcoming charge amount, identity of the merchant, expected transaction description of expected upcoming charge, and the block charges option available to the user to manage the subscription type service.

If third party intermediary 240 supports subscription management options for the service of the merchant corresponding to the upcoming transaction charge (step 335: yes), then server 230 may receive a message from the third party intermediary identifying the supported subscription management options in step 345. Further, server 230 adds the available subscription management options from the third party intermediary to the upcoming transaction data in upcoming transaction data memory 224.

After adding the available subscription management option to the upcoming transaction data in step 340, server 230 sends upcoming transaction data to a financial institution mobile app on user mobile device 202 in step 350. In this case, the upcoming transaction data may include expected upcoming charge date, expected upcoming charge amount, identity of the merchant, expected transaction description of upcoming charge, regular cadence of the charge, and the subscription management options available to the user to manage the subscription type service.

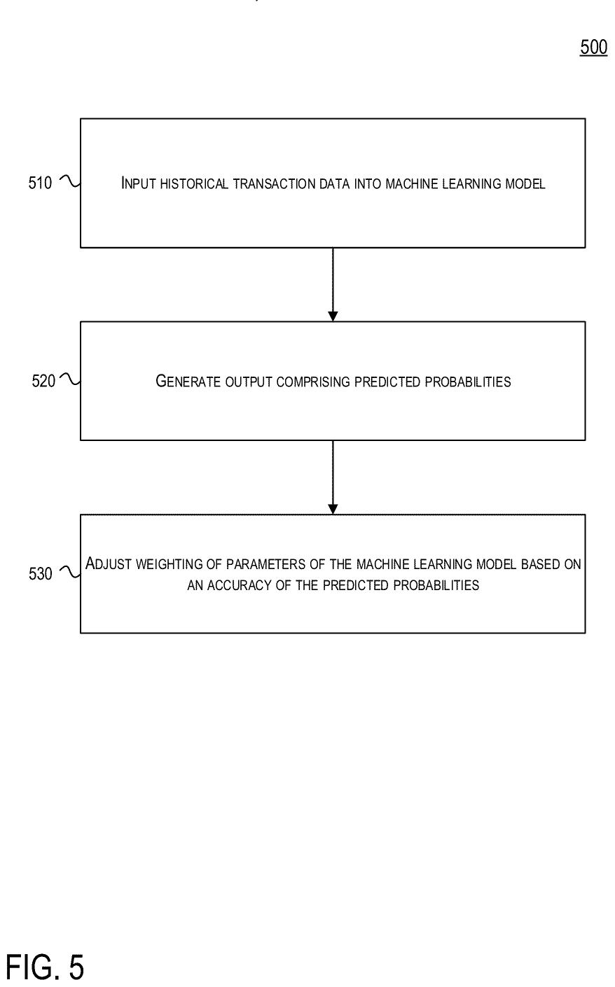

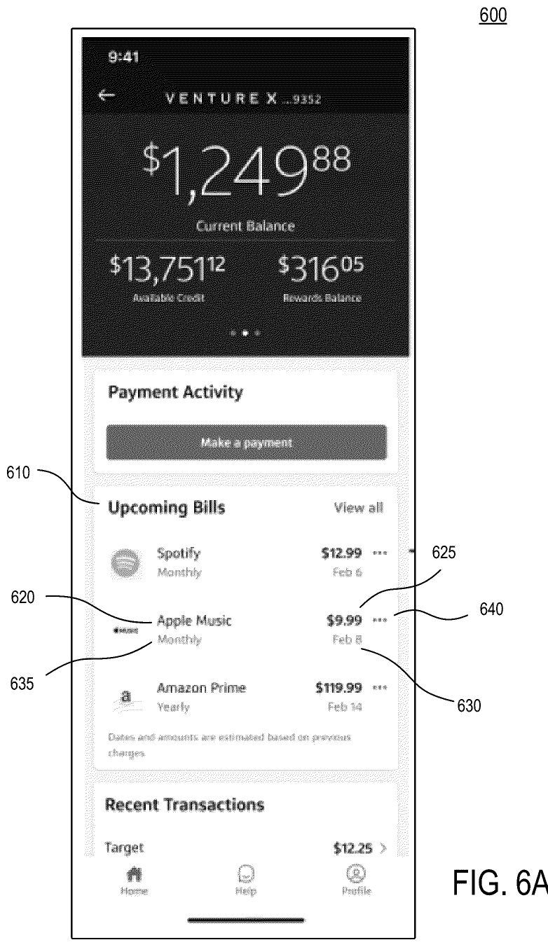

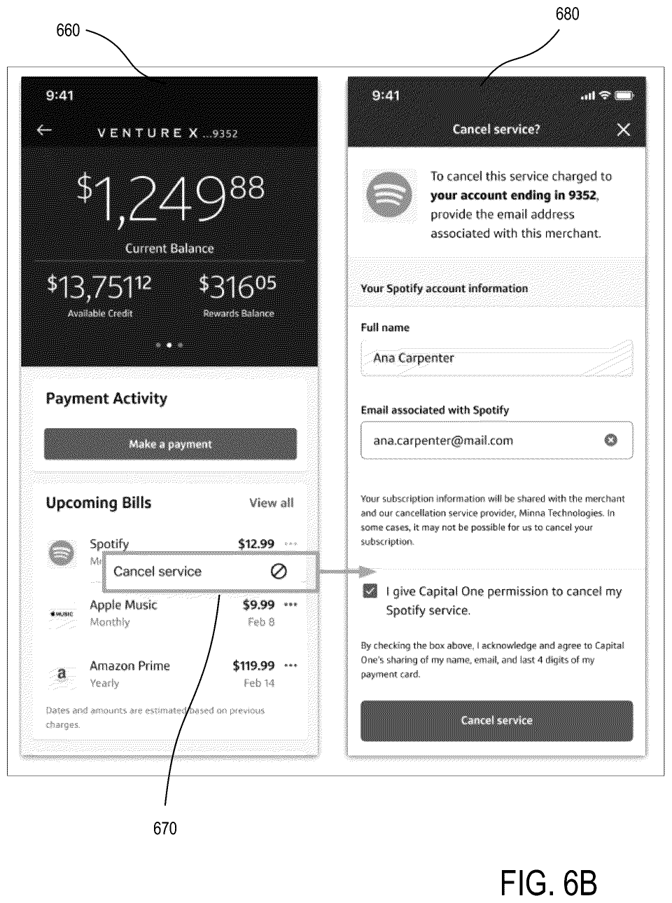

Following step 350 (taking either pathway from step 335), in step 355 when the user 201 accesses their account associated with their electronic payment method (e.g., credit account) on the financial mobile app on mobile device 202, the mobile app may display upcoming transactions, which are subscription type and any available options for managing the subscriptions. An illustrative user interface screen 600 in the mobile app displaying the upcoming transactions for a credit card is shown in FIG. 6A.

On screen 600, upcoming transactions (recurring transactions) as may be identified as upcoming bills 610 may be listed separately from recent transactions for the user to view. In this example, three upcoming transactions are listed with their corresponding upcoming transaction data. For the second upcoming bill listed, the merchant name 610, expected upcoming charge amount 625, expected upcoming charge date 630, and recurring charge period (regular cadence) 635 may be displayed on screen 600. The upcoming bills listed may be presented to include the next three expected upcoming charges, or one, all or less than all of the expected upcoming charges, which may be limited based on the available screen real estate. Also, on the display next to the expected upcoming charge amount 625 may be three dots ( . . . ) as shown on screen 600. By user selection of three dots region 640, via a user input (e.g., tap, point and click, voice or other known input method) to mobile device 202, a menu may appear providing a list of one more options for managing the subscription.

As shown illustrated in FIG. 6B, screen 660 may appear in response to the user input and provide an option 670 which the user may select. In step 360, the mobile app determines (e.g., detects) whether the user 202 has selected the option. If the user does not select any option (step 360: no), it may be that they have exited the display screen displaying the option in step 362.

If the user selects the option in step 360, in step 365 the mobile app, alone or via communication with server 240, may determine if the selected option is a subscription management option available from third party intermediary 240. For example, the upcoming transaction data may include a field to indicate to the mobile app whether the subscription management options are from the third party intermediary or correspond to in house options provided by the financial institution (e.g., block charges).

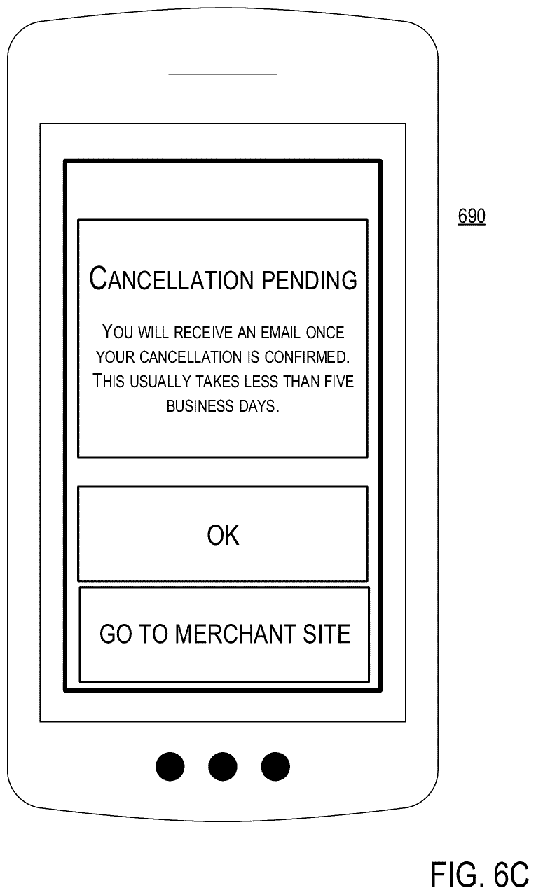

If the selected option does not correspond to a subscription management option available from the third party intermediary (step 365: no), the selected subscription may correspond to the financial institution block charges management option. In this case, in step 366, the mobile app may display a confirmation screen to the user, such as the screen 700 shown in FIG. 7, requesting the user to confirm that they would like to block future charges. If the user does not confirm they wish to block charges then control may return to step 355 or the user may exit the mobile app. If the user confirms they wish to block charges from the particular merchant for the service (step 366: yes), then in step 368 the mobile app may send an instruction to server 230 to block charges for the merchant associated with the upcoming transaction. As discussed, one or more example implementations of the block charges function is described in co-pending, U.S. patent application Ser. No. 18/086,836 filed Dec. 22, 2022 and co-pending U.S. patent application Ser. No. 18/051,705 filed Nov. 1, 2022, both of which are incorporated by reference herein.

If the selected option corresponds to a subscription management option available from the third party intermediary such as by the user selecting the “cancel service” option 670 on screen 660 in FIG. 6B, the mobile app may display a confirmation screen in step 369 similar to screen 700 shown in FIG. 7, but for a service option alter instruction such as pause or cancel, requesting the user to confirm that they would like to block future charges. If the user does not confirm they wish to confirm the service management alter instruction (step 369: no), then control may return to step 355 or the user may exit the mobile app.

In the event, the user selects to continue with the alter instruction in step 369, then the alert instruction may be sent to server 230, which in turns may continue with the optional steps 375, 380 and 385 as shown in dotted box 370 or may skip steps 375, 380 and 385 in dotted box 370, and send the instruction to third party intermediary 240 in step 390. Some alter instructions may have further information to be input by the user before the instruction is sent to third party intermediary 240.

For example, a user may need to provide authorization for the financial institution to act on behalf of the user to send an instruction to cancel a service. In the example, in FIG. 6B, based on the user selecting the “cancel service” option, a form may be provided to the user as illustrated on screen 680. The form may request user 201 to enter their name, email associated with their service account with the merchant and an authorization for financial institution 200 to cancel the service as requested by the user. Upon submission of the form confirming user cancellation of the service and providing financial institution authorization, the mobile app sends the form to server 230, which stores the authorization form in customer consent memory 226. Also, responsive to submission of the form, a cancellation pending screen may be displayed to the user. An example cancellation pending screen may be similar to screen 690 shown in FIG. 6C, and may advise the user that they will be notified of the result of the cancellation in several days by email.

Upon receiving a cancel instruction or pause instruction in step 360, server 230 may store user the corresponding cancellation data or pause in user cancellation and pause data store 228. The user cancellation data may include user identity information, the date of cancellation, user's electronic payment method, and at least some of the upcoming transaction data such as the merchant identity and the identity of the service requested to be cancelled. The user pause data may include user identity information, the date of pause, user's electronic payment method, and at least some of the upcoming transaction data such as the merchant identity and the identity of the service requested to be paused.

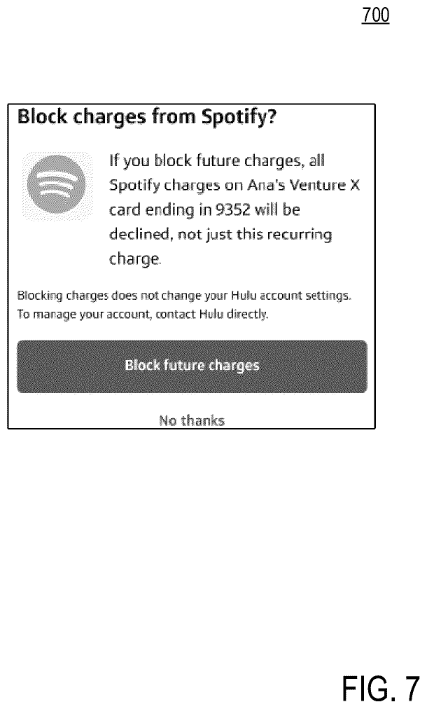

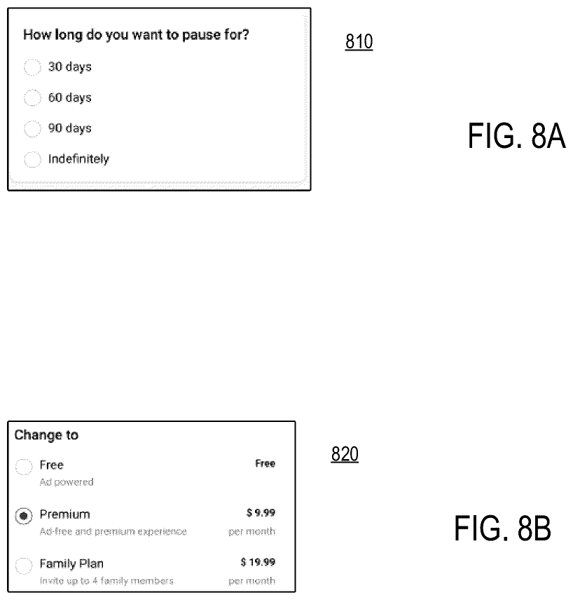

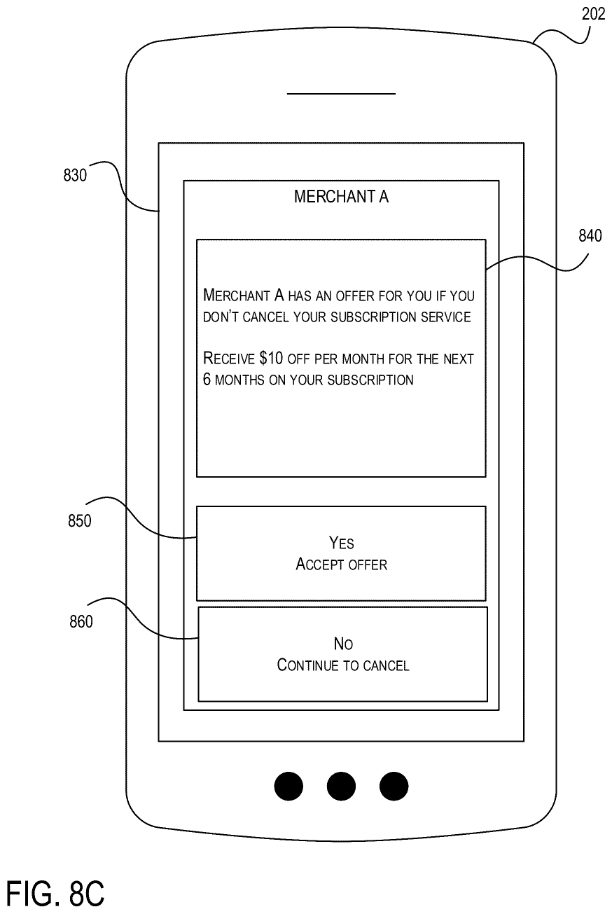

In an example, in which user 201 selects to pause service in step 360, which is a service management option of the third party intermediary, prior to confirming the pause instruction in step 369, the mobile app may display screen 810, as shown in FIG. 8A, prompting user 201 to select the duration of the pause of service. Based on user selection of the pause duration, the process may continue with confirmation being carried out in step 369.

In an example, in which user 201 selects to change service in step 360, which is a service management option of the third party intermediary, prior to confirming the change instruction in step 369, the mobile app may display screen 810 prompting user 201 to update their service plan by selecting one of the available plans. Based on user selection of the service plan, the process may continue with confirmation being carried out in step 369.

In an example, in which user 201 selects to update their payment method in step 360, which is a service management option of the third party intermediary, prior to confirming the updated payment method instruction in step 369, the mobile app may display a screen 820, as shown in FIG. 8B, prompting user 201 to provide, for example, updated account information (e.g., virtual card number, credit card number, card expiration date, security code). Based on the user updating their electronic payment method, the process may continue with confirmation being carried out in step 369.

In certain aspects such as when the alter instruction corresponds to a cancel service instruction or pause service instruction, after receiving confirmation of the alter instruction in step 369, the mobile app may present the user with an offer in their mobile app to continue their service or provide options for updating their service on the display of mobile device 202 in step 375. An example of an offer a user could receive is shown on screen 830 of mobile device 202 in FIG. 8C. In this example, offer 840 provides the user a $10 monthly discount for the next six months to maintain their service. The user may accept the offer by selecting region 850 on screen 830 or decline the offer and continue to cancel (or pause) service by selecting region 860 on screen 830. In step 380, the mobile app determines whether the user accepted or declined the offer.

In another example, after receiving confirmation of the alter instruction in step 369, the mobile app may present the user with a service update screen similar to screen 820 in FIG. 8B along with selection regions similar to 850 and 860, but tailored for a user updating their service type. As in the offer example, the user may select an option to update their service plan by selecting a service option and selecting an accept update region or decline to change/update their service plan and continue to cancel (or pause) service by selecting a decline region on the user interface of the mobile app. In step 380, the mobile app determines whether the user decided to update/change their service plan or continue with canceling or pausing service.

If the user has selected to accept the promotional offer or update their service plan in step 380, the mobile app sends an updated alter instruction corresponding to the accepted promotional offer or updated service plan to server 230. Server 230 may send the updated alter instruction, via third party intermediary APIs including service management functions API 244. Third party intermediary 240 then sends the updated alter instruction to the appropriate merchant, such as merchant A 255, merchant B 265, or merchant C 275 in step 385.

If the user has selected to decline the promotional offer or not update their service plan in step 380, the mobile app sends the original alter instruction (e.g., cancel service, pause service) to server 230 as part of step 390. Server 230 may send the original alter instruction to third party intermediary 240, via third party intermediary APIs including service management functions API 244 as further part of step 390.

For a cancel instruction, an authorization form may be sent by server 230 of financial institution 200, via the letter of attorney API 246, to third party intermediary 240 along with the cancel instruction being sent to service management functions API 244. Third party intermediary 240 may then send the original alter instruction to the appropriate merchant, such as merchant A 255, merchant B 265, or merchant C 275 in step 385. After receiving a cancel instruction, server 230 may store user cancellation data in user cancellation and pause data store 228.

The user cancellation data may include user identity information, the date of cancellation, user's electronic payment method, and at least some of the upcoming transaction data such as the merchant identity and the identity of the service requested to be cancelled. It will be appreciated that certain subscription for services may not be cancelable until a contract for the service, which may not correspond to the regular cadence of payments, has expired. In this instance, the cancel option may not be identified as an available service management option by the third party intermediary, or the option may be identified as available when in truth it can actually only be carried out when a user is not under a contract. In a case where third party intermediary 240 communicates the cancel instruction to the relevant merchant, the merchant may respond to the third party intermediary with a message that the service may not be cancellable or is only cancellable by payment of early termination fee, or has been successfully executed. That information can be sent by third party intermediary to financial institution 200. Referencing the user cancellation data in user cancellation and pause data store 228, server 230 can send a notification to the user regarding status of their cancel request. Notification may be sent to any or all of the user's mobile app, email address on file, or mobile phone via text.

Steps 375, 380, and 385 may not be employed and skipped or only employed for certain management functions such as cancel service or pause service. For example, in a case where a user has selected to update their subscription and has not does so based on being presented with any promotional offer or with a subscription update option after selecting another subscription management option (e.g., cancel or pause), third party intermediary 240 may send, immediately after confirming the alter instruction in step 369, the alter instruction to third party intermediary 240, via third party intermediary APIs including service management functions API 244. Third party intermediary 240 then sends the original alter instruction to the appropriate merchant, such as merchant A 255, merchant B 265, or merchant C 275. In this case, step 390 may immediately follow receiving user confirmation of the alter instruction in step 369. This sequence may also occur where the user has selected the update electronic payment method service management option and updated their electronic payment method prior to confirming, in step 369, the update electronic payment method alter instruction.

Financial institution 220 may provide the ability to unblock (allow) blocked charges when blocked via internal block charge function. Also, third party intermediary may provide service management options including restart a paused service and resubscribe to a canceled service. Financial institution may maintain records of paused services and canceled services in user cancellation and pause data store 228, and may maintain records of blocked services in a blocked services store or in user cancellation and pause data store 228. The financial institution may maintain an inactive (e.g., paused, canceled, blocked) service list with the merchant identifier and user information in user cancellation and pause data store 228 and update that list each time a new service becomes inactive or a previously inactive service is reactivated. The list may be forwarded by server 230 to the user's mobile app for display to user 201 on the screen of mobile device 202.

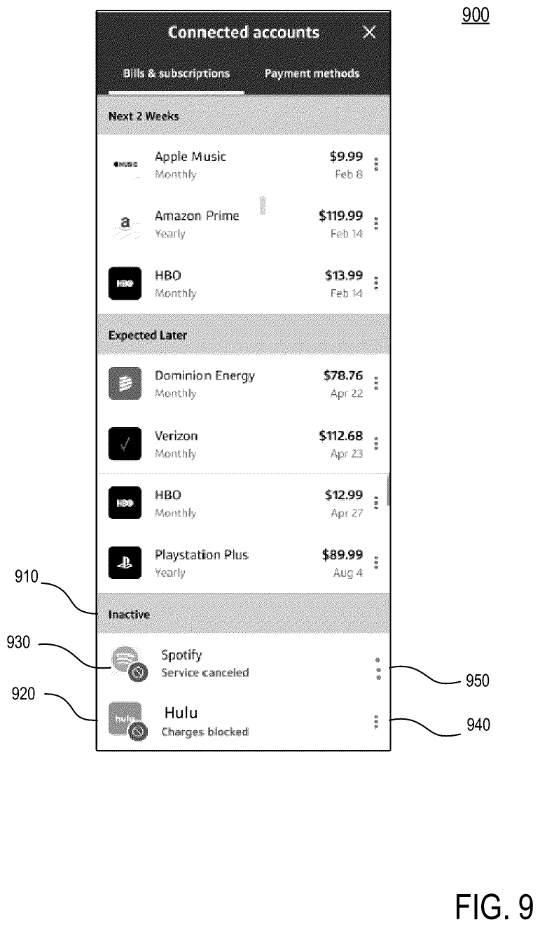

An example screen may include a list of upcoming transactions and a list of inactive subscription services such as illustrated in FIG. 9. On screen 900, inactive list 910 is shown with a service 920 for which charges are blocked and a service 930 which has been canceled. By selecting three dots region 930 next to blocked service 920, the user may be presented with a subscription management option to “allow charges”. In this case, the mobile app, following user confirmation of the allow charges instruction, sends the allow charges instruction to server 230, which causes further charges from the merchant for the service, which was previously blocked, to be allowed and processed and updates a blocked charges data store or user cancellation and pause data store 228. By selecting three dots region 950 next to canceled service 930, the user may be presented with a subscription management option to “resubscribe to service”. In this case, the mobile app, following user confirmation of the resubscribe instruction, sends the resubscribe instruction to server 230, which then sends the resubscribe instruction send to third party intermediary 240, via third party intermediary APIs including service management functions API 244. Third party intermediary 240 then sends the resubscribe instruction to the appropriate merchant, such as merchant A 255, merchant B 265, or merchant C 275. Also, server 230 updates user cancellation and pause data store 228 based on the resubscribe instruction.

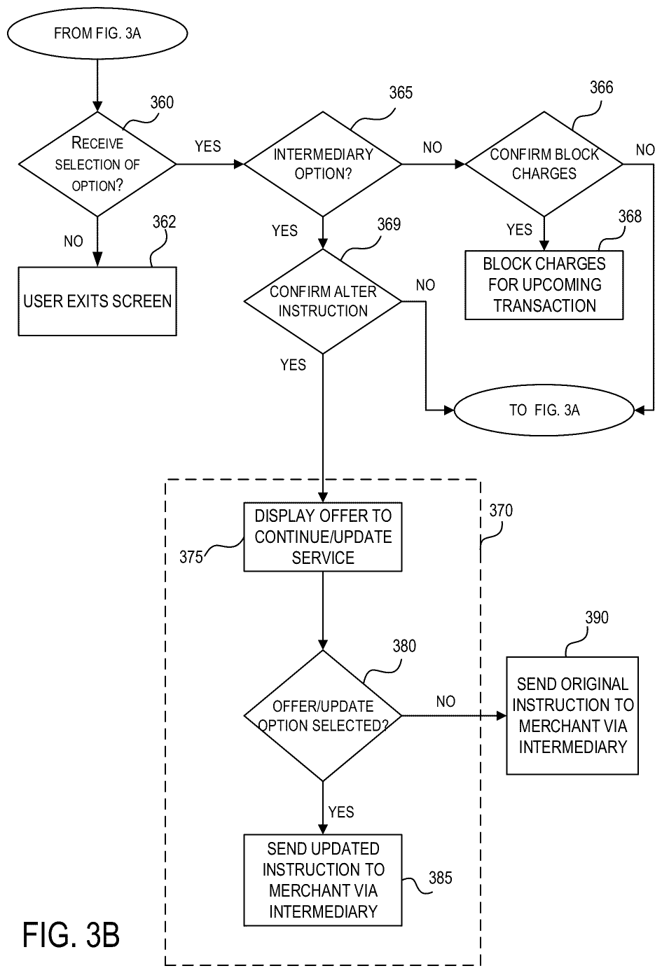

FIG. 4 is an illustrative flowchart of a machine learning model determining a probability that historical charge data of a user associated with a merchant corresponds to a recurring transaction according to aspects of the disclosure.

In step 410, the server 230 may determine one or more websites to scrape based on use of a browser extension that is configured to detect one or more keywords associated with subscription type recurring transactions. For example, after the browser extension detects that a web page of a website associated with a merchant has been accessed, the browser extension may scrape one or more web pages to determine whether web pages of the websites comprise one or more key words associated with a subscription type recurring transaction for the merchant. For example, the browser extension may detect that a user is at a web page associated with a transaction (e.g., a subscription page, a payment page, and/or a service renewal page associated with the merchant). The determination that a user is at a web page associated with a transaction may be based on detection of one or more payment fields within a web page. Based on detecting the one or more payment fields, the browser extension may then search the web page for one or more key words associated with subscription type recurring transactions. For example, the browser extension may search for one or more key words comprising subscription, subscribe, preauthorized, recurring, transaction, renewal, payment, monthly, quarterly, weekly, biweekly, annual, and/or yearly.

By way of further example, after detecting that a user is at a web page associated with a transaction, the browser extension may search the web page for content comprising one or more transaction amounts (e.g., one or more monetary amounts associated with the purchase of goods or services) associated with subscriber type recurring transactions. For example, if the server has determined that the merchant offers subscription services for $14.99 per month, the browser extension may search for a transaction amount of $14.99. When the transaction amount of $14.99 is found, the browser extension may determine whether the transaction amount is in close proximity to (e.g., adjacent to) some indication (e.g., the one or more keywords) that the transaction amount is a subscription recurring transaction. If the transaction amount and/or the one or more key words are associated with subscription recurring transactions, the browser extension may determine that one or more websites associated with the web page will be scraped.

As described herein, a browser extension may be an extension of a browser application that is implemented on a computing device (e.g., the computing devices 101, 107, 108, and/or 109) in order to access websites via a network (e.g., the network 103 illustrated in FIG. 1). In some aspects, the browser extension may be part of a standalone application that may be used to browse websites associated with a particular merchant or a set of merchants.

In step 420, a computing device may scrape one or more websites associated with a merchant for content comprising one or more key words associated with preauthorized recurring transactions. As part of scraping the one or more websites the computing device may access a website associated with a merchant (e.g., a website at which goods or services or a merchant may be purchased), the computing device may search web pages of the website for one or more key words associated with subscriber type recurring transactions. For example, the browser extension may search for one or more key words comprising subscription, subscribe, preauthorized, recurring, transaction, renewal, payment, monthly, quarterly, weekly, biweekly, annual, and/or yearly. Scraping the one or more websites for the content may comprise generating statistics that indicate the frequency of the one or more keywords, the frequency of different combinations of the one or more keywords, the location of the one or more keywords within the web pages, and/or the location of the one or more keywords relative to one or more other keywords.

In step 430, the computing device may train machine learning model 225. The machine learning model may be trained based on the content comprising the one or more key words. Training the machine learning model may comprise providing an input comprising the one or more key words to the machine learning model. The machine learning model may comprise parameters (e.g., adjustable weights and fixed biases) and each of the weights of the machine learning model may be adjusted based on the extent to which each of the weights contributes to increasing or decreasing the accuracy of output generated by the machine learning model. Based on use of a loss function, the parameters may be adjusted such that the loss is minimized (e.g., the output of the machine learning model more closely corresponds to ground truth output that represents optimal output). For example, the parameters that contribute to increasing the accuracy of the output of the machine learning model may be increased and the parameters that contribute to decreasing the accuracy of the machine learning model may be decreased.

For example, the machine learning model may receive input comprising key words (combinations of key words may form key phrases) from a web site of a merchant. The ground truth data may comprise sets of key words that are present in the transaction data (e.g., the transaction description field) of incoming charges that are subscription type recurring transactions. The machine learning model may be trained to determine the probability that historical charge data corresponds to a subscription type recurring transaction based on the extent to which the probability that historical charge data represents a subscription type recurring transaction corresponds to whether the historical charge data actually represents a subscription type recurring transaction.

FIG. 5 is an illustrative flowchart of one aspect of the disclosure in which a machine learning model 225 is trained using various training data according to aspects of the disclosure.

In step 510, the server(s) 230 may input historical transaction data retrieved from the data storage 222 into machine learning model 225. The historical transaction data may comprise historical incoming charges for services from a plurality of merchants. For example, the historical transaction data for each individual transaction may comprise a merchant identifier, A merchant category code, a date on which the transaction was posted, the amount charged to the electronic payment method, and a transaction description. By evaluating consecutive transaction dates with charges of the same amount from the merchant, machine learning model 225 may evaluate the duration between consecutive charges and determine if the historical transaction data indicates a recurring transaction for a service at a regular cadence (e.g., monthly, bimonthly, weekly, biweekly, quarterly, annually, semi-annually, every 30 days, every 60 days, every 90 days). Also, the merchant category code may be evaluated to determine if the types of goods or services associated with the transaction may represent a subscription type recurring transaction. Further, machine learning model 225 may evaluate a description field of the past transactions to determine if the past charges may be associated with ground truth labels indicating whether each of the past transactions is a subscription type recurring transaction rather than an instance in which a user has, for example, made a purchase on the same day for several consecutive weeks. The ground truth labels may comprise sets of key words that may be present in the description field and indicate whether each of the past charges is a subscription type recurring transaction at a regular cadence. As a result, when a predicted probability of a series of past transactions (historical transaction data) is generated representing whether a subscription type recurring transaction with a regular cadence, the ground truth labels may be used to determine the accuracy of machine learning model 225 with respect to the predicted probabilities that were generated.

Further, machine learning model 225 may compare the merchant identifier, past charge amounts, merchant category code, transaction description and the regular cadence with the historical transaction data of other users for similarities. As a result, when a predicted probability of a series of past transactions is a subscription type recurring transaction with a regular cadence, the historical transaction data of other users may be used to increase the accuracy of machine learning model 225 with respect to the predicted probabilities that were generated.

In step 520, the server 230 may generate, based on machine learning model 225 and the historical transaction data, output comprising predicted probabilities that the past charges from the merchant are subscription type recurring transactions. For example, machine learning model 225 may analyze one or more aspects of the historical transaction data based in part on the configuration of parameters of the machine learning model. Machine learning model 225 may then generate predicted probabilities comprising probabilities that each of the past charges at a regular cadence from a particular merchant is a subscription type recurring transaction.

In step 530, server(s) 230 may adjust a weighting of parameters of machine learning model 225 based on an accuracy of the predicted probabilities. For example, the weighting of parameters that are determined to make a greater contribution to accurately predicting whether past charges correspond to a subscription type recurring transaction may be increased. The weighting of the parameters, in certain instances, may be adjusted based on number of past charges at the regular cadence. Further, the weighting of parameters that are determined to make a lesser contribution (or no contribution) to accurately predict whether past charges is a subscription type recurring transaction may be decreased. Machine learning model 225 may be iteratively trained until the accuracy of the predicted probabilities is sufficiently high.

FIG. 10 is an illustrative flowchart of a machine learning model determining a probability that a user's historical transaction data including past charges for the particular merchant indicate a subscription type recurring transaction according to aspects of the disclosure. More specifically, FIG. 10 provides an example of the process details of step 310 from FIG. 3A.

In step 1010, the machine learning model (e.g., a machine learning model similar to the machine learning model 127 in FIG. 1) may determine, based on the value of a CVV field being present in one or more of the past transactions of the historical transaction data from the merchant, that the probability of the past probability being based on a subscription type recurring transaction is negatively correlated with the CVV field indicating that one or more past charges were based on a card present transaction (e.g., a past charge for a card present is less likely to be a subscription type recurring transaction). For example, the machine learning model may receive historical transaction data indicating that the CVV value of a CVV field for a past charge indicates a card present transaction in which a physical credit card was used to perform the transaction associated with the past charge(s). Based on the value indicated in the CVV value and the greater likelihood that card present transactions are more likely to be for one-time purchases, the machine learning model may reduce the generated probability the historical transaction data including the past transactions represent a subscription type recurring transaction.

In step 1020, the machine learning model may determine, based on a payment method field being present in one or more of the past transactions of the historical transaction data, that the probability of the past charges being based on subscription type recurring transaction is negatively correlated with the payment method field indicating that one or more of the past charges is based on a credit/debit card transaction using a card reader device or a mobile wallet transaction using a mobile device and a contactless point of sale system. For example, the machine learning model may receive transaction data indicating that the payment method for a past charge indicates the use of a prepaid account associated with a restaurant chain (e.g., a prepaid gift card) or prepaid card to perform the transaction associated with the past charge(s). Based on the payment method being a prepaid account or prepaid card, and thereby more likely to be a one-time purchase, the machine learning model may reduce the probability of the past charges being a subscription type recurring transaction.

In step 1030, the machine learning model may determine, based on a merchant category code field being present in one or more of the past transactions of the historical transaction data, that the probability of the past charges being based on a subscription type recurring transaction is positively correlated with the merchant category code (e.g., a four digit code indicating the type of good or service provided by a merchant) field indicating that a category of goods or services provided by the merchant correspond to a subscription type recurring transaction. For example, the machine learning model may receive transaction data indicating that the merchant category code associated with the past charges indicates that the merchant is part of a chain of fitness centers which increases the likelihood that the past charge are for the type of good or service that is more likely to be a subscription type recurring transaction. Based on the merchant category code indicating that the merchant is part of a chain of fitness centers, the machine learning model may increase the probability of the past charges corresponding to a subscription type recurring transaction.

In step 1040, the machine learning model may determine, based on a recurring transaction field being present in one or more of the past transactions of the historical transaction data, that the probability of the past charges being based on subscription type recurring transaction is positively correlated with the recurring transaction field indicating that the past charges correspond to a recurring transaction. For example, the machine learning model may receive transaction data indicating that the recurring transaction value of a recurring transaction field for past charges indicates that the past charges correspond to a recurring transaction. Based on the recurring transaction field indicating a recurring transaction, the machine learning model may increase the probability of the past charges corresponding to subscription type recurring transaction.

The recurring transaction field may not be dispositive of a subscription type recurring transaction. Further, the value in the recurring transaction field may have been erroneously entered and other portions of the transaction data may contraindicate the value in the recurring transaction field. For example, if the recurring transaction field indicates that a past charge was for a recurring transaction, other portions of the transaction data such as a transaction description field indicating that the incoming charge is for the purchase of a theater ticket on a particular day may reduce the probability that the incoming charge is a subscription type recurring transaction.

In step 1050, the machine learning model may determine, based on a transaction description field of the transaction data, that the probability of the past charges corresponding to a subscription type recurring transaction is positively correlated with one or more key words describing the past charges as a subscription type recurring transaction. For example, the machine learning model may receive historical transaction data in which the transaction description field indicates that the one or more past charge is for a “MONTHLY MAGAZINE SUBSCRIPTION PAYMENT” which includes the key words “monthly” and “subscription” which are associated with a subscription type recurring transaction. Based on the one or more key words comprising “monthly” and “subscription” the machine learning model may increase the probability of the past charges corresponding to a subscription type recurring transaction.

In step 1060, the machine learning model may determine that the probability of the past charges corresponding to a subscription type recurring transaction is positively correlated with an amount of the past transaction charges matching a subscription cost of the merchant. For example, the machine learning model may receive transaction data indicating that the amount (e.g., the monetary amount) of each past charge is “$12.99” which exactly matches the price of a subscription to a gaming service of the merchant. Based on the amount of the past charges matching the subscription cost of the merchant, the machine learning model may increase the probability of the past charges corresponding to a recurring transaction. It will be appreciated that a change in subscription cost may be detected as well based on information obtained by the financial institution from, for example, the merchant's website or correlated with past transactions of other users showing a subscription price change during the same period represented in the user's past transactions.

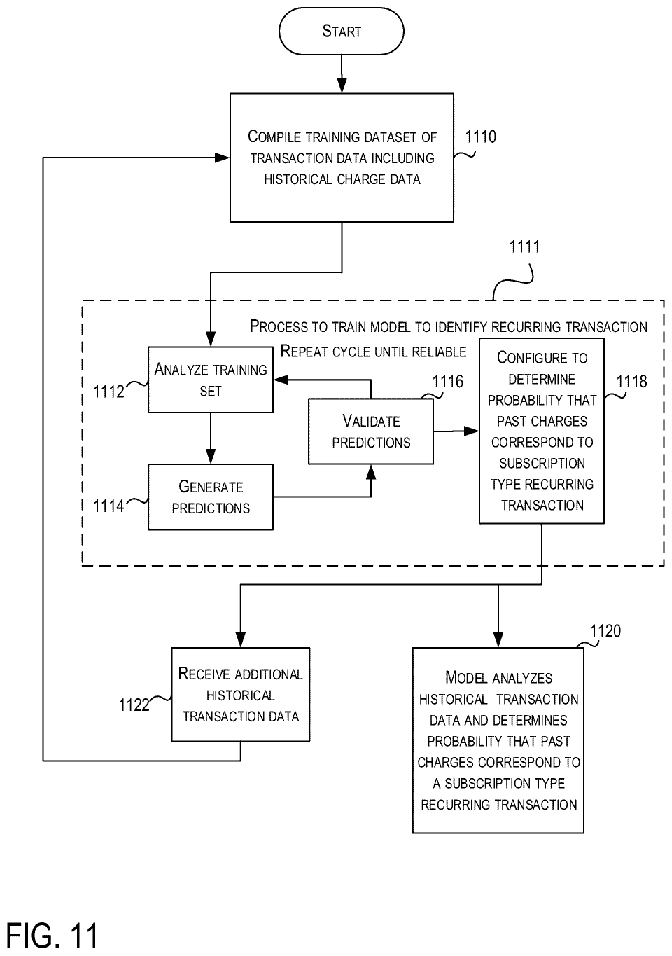

FIG. 11 is an illustrative flowchart representation of a process for training a transaction identification model according to aspects of the disclosure.

The training dataset may be compiled in step 1110. The training dataset, may be similar to the training dataset 129 depicted in FIG. 1, and may be based on historical transaction data from a plurality of merchants and/or users (e.g., users of goods and/or services of the merchants). Further, the training dataset may comprise data obtained from other sources including third-party data providers, analytics providers, merchant-provided information indicating the way in which past charges from those merchants may be structured.

In step 1112, a transaction identification model (e.g., a machine learning model similar to the machine learning model 127 described in FIG. 1) may analyze the training dataset. Based on the analysis of the training dataset, the transaction identification model may generate predicted probabilities that past charges correspond to subscription type recurring transactions in step 1114.

In step 1116, the predicted probabilities generated in step 1114 may be validated against ground truth output that indicates which sets of past charges within the training dataset in step 1116 correspond to subscription type recurring transactions and which sets of the past charges are do not correspond to subscription type recurring transactions. The transaction identification model may then use the validations to improve the performance of the transaction identification model by iteratively cycling through the steps of analysis, prediction, and validation until the transaction identification model is configured and/or trained to accurately determine the probability that a set of past charges corresponds to a subscription type transaction identification in step 1118. Steps 1112, 1114, 1116, and 1118 together provide an example of a process 1111 to train the machine learning model to identify recurring transactions and to repeat the cycle in 1112, 1114, and 1116 until the machine learning model becomes reliable.

After being configured for use, in step 1118, the transaction identification model may analyze historical transaction data and determine the probability that a set of past charges corresponds to a subscription type recurring transaction in step 1120. At this point, the transaction identification model may be used as described herein.

Further, after performance of step 1118, the transaction identification model may be updated over time with an additional transaction dataset in step 1122. In step 1122, the transaction identification model may receive new datasets and iterate through the process previously described in steps 1112-1118. The new datasets may comprise additional sets of past charges, merchant identifiers, CVVs, merchant category codes, transaction descriptions, amounts of past charges, and/or other information that may be used to determine the probability that a past charge for a merchant is a subscription type recurring transaction. The training dataset may be obtained from third parties or compiled based on a plurality of transaction data as described in step 1110. After completing training of the transaction identification model in steps 1112-1118 using the additional transaction data from step 1122, the transaction identification model may, in accordance with the embodiments described herein, be used to determine the probability that past charge data of a user corresponds to a subscription type recurring transaction as described in step 1120.

It will be appreciated that some of the above aspects may be applicable to a scenario in which a merchant is not listed on a blocked merchants list or a blocked merchants list is not available for use in the determination of whether the merchant is on the blocked merchants list. In such cases, a method may comprise receiving transaction data comprising transaction details for an incoming charge associated with a merchant. The merchant may be determined to be included in a blocked merchants list and authorization of incoming charges for preauthorized recurring transactions associated with the merchant may be blocked. Further, based on a machine learning model and the transaction data, a probability that the incoming charge for the merchant is a preauthorized recurring transaction may be determined. The machine learning model may be configured to identify preauthorized recurring transactions based on the transaction data. Based on the probability not exceeding a threshold probability, the authorization of the incoming charge may be prevented from being blocked.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed and/or implemented using any manner of device, system, apparatus, and/or non-transitory computer readable media including the computing devices, computing systems, computing apparatuses, and/or non-transitory computer readable media that are described herein.

What is claimed is:

1. A non-transitory computer readable medium having instructions stored thereon that, when executed by one or more processors, cause the one or more processors to perform steps comprising:
storing, historical transaction data comprising transaction details for received past charges for services to an electronic payment method of a user, wherein the past charges are associated with a plurality of merchants;
generating, based on a machine learning model analyzing the historical transaction data comprising past charges to the electronic payment method for a service of a corresponding merchant of the plurality of merchants, a probability that the past charges for the service indicate a subscription type recurring transaction for the service of the corresponding merchant;
based on the probability exceeding a threshold,
determining that the past charges correspond to a subscription type recurring transaction for a subscription type service of the corresponding merchant, and
determining an expected amount of an upcoming charge and an expected payment date for the upcoming charge;
receiving, from a third party intermediary, notice of an option available to a user for cancelling the subscription type service of the corresponding merchant;
providing, to an application executing on a mobile computing device and for display on the mobile computing device, the expected amount of the upcoming charge, the expected payment date for the upcoming charge, an identity of the corresponding merchant, and the option available to the user for cancelling the subscription type service of the corresponding merchant;
receiving, from the application, a cancel instruction to cancel the subscription type service of the corresponding merchant;
based on receiving the cancel instruction, providing, to the application for display on the mobile computing device, an offer to continue the subscription type service;
receiving from the application one of a first indication that the offer to continue the subscription type service was accepted by the user or a second indication that the offer to continue the subscription type service was declined by the user;
based on receiving the first indication, sending, via the third party intermediary to the corresponding merchant, service update information updating terms of the subscription type service for the user;
based on receiving the second indication, sending, via the third party intermediary to the corresponding merchant, the cancel instruction;
training the machine learning model based on:
inputting the historical transaction data for the service of the corresponding merchant into the machine learning model;
generating, based on the machine learning model and the historical transaction data, output comprising predicted probabilities that the past charges represent subscription type recurring transactions for the service of the corresponding merchant; and
adjusting a weighting of parameters of the machine learning model based on an accuracy of the predicted probabilities.

2. A method comprising:
storing, by a server, historical transaction data comprising transaction details for received past charges for services to an electronic payment method of a user, wherein the past charges are associated with a plurality of merchants;
generating, by the server and based on a machine learning model analyzing the historical transaction data comprising past charges to the electronic payment method for a service of a corresponding merchant of the plurality of merchants, a probability that the past charges for the service indicate a subscription type recurring transaction for the service of the corresponding merchant;
based on the probability exceeding a threshold,
determining, by the server, that the past charges correspond to a subscription type recurring transaction for a subscription type service of the corresponding merchant, and
determining an expected amount of an upcoming charge and an expected payment date for the upcoming charge;
receiving, by the server and from a third party intermediary, notice of one or more options available to a user for altering the subscription type service of the corresponding merchant;
receiving, by an application executing on a mobile computing device and from the server, the expected amount of the upcoming charge, the expected payment date for the upcoming charge, an identity of the corresponding merchant, and the one or more options available to the user for altering the subscription type service of the corresponding merchant;
displaying, by the application and on the mobile computing device, the expected amount of the upcoming charge, the expected payment date for the upcoming charge, the identity of the corresponding merchant, and the one or more options available to the user for altering the subscription type service of the corresponding merchant;
receiving, by the application and via user input at the mobile computing device, an alter instruction to alter the subscription type service of the corresponding merchant; and
based on receiving the alter instruction, sending, via the third party intermediary to the corresponding merchant, the alter instruction.

3. The method of claim 2, wherein the alter instruction comprises a cancel instruction and the sending, comprises, sending the cancel instruction to cancel the subscription type service of the corresponding merchant.

4. The method of claim 3, further comprising
based on receiving the cancel instruction to cancel the subscription type service, displaying, by the application, an offer to continue the subscription type service.

5. The method of claim 4 further comprising:
receiving, by the application and via second user input to the mobile computing device, an instruction rejecting the offer to continue the subscription type service,
wherein sending the cancel instruction is further based on receiving the instruction rejecting the offer to continue the subscription type service.

6. The method of claim 3, further comprising:
displaying, by the application and on the mobile computing device based on receiving the alter instruction and after the subscription type service has been canceled, an option to reactivate the subscription type service.

7. The method of claim 6, further comprising:
receiving, by the application and via second user input on the mobile computing device, a reactivation instruction to reactivate the subscription type service; and
sending, via the third party intermediary to the corresponding merchant, the reactivation instruction to reactivate the subscription type service.

8. The method of claim 2, further comprising, prior to sending the alter instruction,
prompting the user, by the application and via the mobile computing device, to confirm the alter instruction to alter the subscription type service; and
receiving, via second user input at the mobile computing device, confirmation of the alter instruction to alter the subscription type service.

9. The method of claim 2, wherein the subscription type service of the corresponding merchant comprises a first service plan, and
wherein the alter instruction comprises an instruction to change the first service plan to a second service plan different from the first service plan.

10. The method of claim 2, wherein the alter instruction comprises a pause instruction, and the sending, comprises, sending the pause instruction to pause the subscription type service.

11. The method of claim 10, wherein the one or more options to alter the subscription type service includes an option to pause the subscription type service for a first period and an option to pause the subscription type service for a second period different from the first period.

12. The method of claim 2, further comprising training the machine learning model based on steps comprising:
inputting the historical transaction data for the service of the corresponding merchant into the machine learning model;
generating, based on the machine learning model and the historical transaction data, output comprising predicted probabilities that the past charges represent subscription type recurring transactions for the service of the corresponding merchant; and
adjusting a weighting of parameters of the machine learning model based on an accuracy of the predicted probabilities.

13. The method of claim 2, wherein the displaying comprising displaying the expected amount of the upcoming charge, the expected payment date for the upcoming charge, and the identity of the corresponding merchant in a subscription type recurring transaction list with information of a subscription type recurring transaction for a subscription type service of another merchant, the information of the other merchant comprising an expected amount of the upcoming charge and an expected payment date for the upcoming charge for the subscription type service of the other merchant, and the identity of the other merchant.

14. The method of claim 2, wherein one or more of the past charges comprise a card verification value (CVV) field, and wherein the machine learning model is further configured to perform steps comprising:
determining, based on the CVV field, that the probability of the one or more past charges being based on a subscription type recurring transaction is negatively correlated with the CVV field indicating that one or more of the past charge were based on a card present transaction.

15. The method of claim 2, wherein the transaction details for one or more of the past charges comprises a payment method field, and wherein the machine learning model is further configured to perform steps comprising:
determining, based on the payment method field, that the probability of the past charges being based on a subscription type recurring transaction is negatively correlated with the payment method field indicating that the past charges are based on a card transaction using a card reader device or a mobile wallet transaction using a mobile device and a contactless point of sale system.

16. The method of claim 2, wherein the transaction details for one or more of the past charges comprises a merchant category code field, and wherein the machine learning model is further configured to perform steps comprising:
determining, based on the merchant category code field, that the probability of the past charges being based on a subscription type recurring transaction is positively correlated with the merchant category code field indicating that a category of goods or services provided by the merchant correspond to a subscription type recurring transaction.

17. The method of claim 2, wherein the transaction details for one or more of the past charges comprises a recurring transaction field, and wherein the machine learning model is further configured to perform steps comprising:
determining, based on the recurring transaction field, that the probability of the past charges charge being based on a subscription type recurring transaction is positively correlated with the recurring transaction field indicating that the past charges corresponded to a subscription type recurring transaction.

18. The method of claim 2, wherein the transaction details for one or more of the past charges comprises a transaction description field, and wherein the machine learning model is further configured to perform steps comprising:
determining, based on the transaction description field, that the probability of the past charges being based on a subscription type recurring transaction is positively correlated with one or more key words describing the past charges as a subscription type recurring transaction.

19. A method comprising:
storing, by a server, historical transaction data comprising transaction details for received past charges for services to an electronic payment method of a user, wherein the past charges are associated with a plurality of merchants;
generating, by the server and based on a machine learning model analyzing the historical transaction data comprising past charges to the electronic payment method for a service of a corresponding merchant of the plurality of merchants, a probability that the past charges for the service indicate a subscription type recurring transaction, for the service of the corresponding merchant;
based on the probability exceeding a threshold,
determining, by the server, that the past charges correspond to a subscription type recurring transaction for a subscription type service of the corresponding merchant, and
determining, by server, an expected amount of an upcoming charge and an expected payment date for the upcoming charge;
receiving, by the server and from a third party intermediary, notice of an option available to a user for updating the electronic payment method for the subscription type service of the corresponding merchant;
receiving, by an application executing on a mobile computing device and from the server, an amount of the upcoming charge, an identity of the corresponding merchant, and the option available to the user for updating the electronic payment method for the service of the corresponding merchant;
displaying, by the application and on the mobile computing device, the expected amount of the upcoming charge, the expected payment date for the upcoming charge, the identity of the corresponding merchant, and the option available to the user for updating the electronic payment method for the subscription type service of the corresponding merchant;
receiving, by the application and via user input at the mobile computing device, an update instruction to update the electronic payment method for the subscription type service of the corresponding merchant; and
based on receiving the update instruction, sending, via the third party intermediary to the corresponding merchant, the update instruction for updating the electronic payment method.

20. The method of claim 19, wherein the instructions, when executed by the one or more processors, further cause the one or processors to perform steps comprising:
training the machine learning model based on:
inputting the historical transaction data for the service of the corresponding merchant into the machine learning model;
generating, based on the machine learning model and the historical transaction data, output comprising predicted probabilities that the past charges represent subscription type recurring transactions for the service of the corresponding merchant; and
adjusting a weighting of parameters of the machine learning model based on an accuracy of the predicted probabilities.
